(19) United States
(12) Patent Application Publication
(10) Pub. No.: US 2007/0115787 A1
(43) Pub. Date: May 24, 2007

(54) Planar optical device for generating optical nanojets

(75) Inventors: Amit V. Itagi, Pittsburgh, PA (US); William A. Challener, Sewickley, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/287,543

(22) Filed: Nov. 23, 2005

(51) Int. Cl. G11B 7/135

(52) U.S. Cl. 369/99; 369/112.01

(57) ABSTRACT

An apparatus comprising a first portion and a second portion wherein the first portion includes sides shaped to direct a guided electromagnetic planar waveguide mode to a focal region outside of the first portion. The second portion is adjacent the first portion and contains at least a part of the focal region. The first portion and the second portion are structured and arranged to provide a depth of focus adjacent to the focal region. The depth of focus may be in the range of about 300 nm to about 2000 nm.

### STATEMENT REGARDING FEDERALLY SPONSORED RESEARCH OR DEVELOPMENT

This invention was made with United States Government support under Agreement No. 70NANB1H3056 awarded by the National Institute of Standards and Technology (NIST). The United States Government has certain rights in the invention.

### FIELD OF THE INVENTION

This invention relates generally to planar optical devices and, more particularly, to a planar optical device for generating optical nanojets.

### BACKGROUND INFORMATION

One of the fundamental objectives of optical data storage research has been the generation of small and intense optical spots. This objective has become even more pertinent to the magnetic data storage industry with the conceptualization of a heat assisted magnetic recording system. Some devices for generating small optical spots use: a focusing device, such as a lens, that bends the optical rays toward a common point; small apertures in metal that generate evanescent fields; or a combination of a lens and an aperture.

Heat assisted magnetic recording (HAMR) has been proposed as a means by which the recording density of hard disc drives may be extended to 1 Tb/in² or higher. Current conventional hard disc drive technology is limited by the superparamagnetic effect, which causes the small magnetic grains needed for high density recording media to gradually lose their magnetization state over time due to thermal fluctuations. By using heat assisted magnetic recording, the magnetic anisotropy of the recording medium, i.e. its resistance to thermal demagnetization, can be greatly increased while still allowing the data to be recorded with standard recording fields. In HAMR, a laser beam heats the area on the disc that is to be recorded and temporarily reduces the anisotropy, and hence coercivity, in just that area sufficiently so that the applied recording field is able to set the magnetic state of that area. After cooling back to the ambient temperature, the anisotropy returns to its high value and stabilizes the magnetic state of the recorded mark.

In HAMR, it is necessary to generate extremely small optical spots (<<100 nm) in order to heat the recording medium for reducing the local coercivity of the medium sufficiently for magnetic recording. One way to generate a small optical spot is to insert light into a planar solid immersion mirror (PSIM) that focuses the light by means of its shape. The depth of focus of the PSIM is typically very small and it may actually be located at a point different from the geometric focus of the PSIM. Therefore, the tolerances for manufacturing the PSIM are very tight.

Accordingly, there is identified a need for an improved PSIM that overcomes limitations, disadvantages, or shortcomings of known PSIMs. In addition, there is identified a need for an improved PSIM that is capable of generating sufficiently small optical spots while maintaining a sufficient depth of focus.

### SUMMARY OF THE INVENTION

The invention meets the identified need, as well as other needs, as will be more fully understood following a review of this specification and drawings.

An aspect of the present invention is to provide an apparatus comprising a first portion and a second portion. The first portion includes sides shaped to direct a guided electromagnetic planar waveguide mode to a focal region outside of the first portion. The second portion is adjacent the first portion and contains at least a part of the focal region. The first portion and the second portion are structured and arranged to provide a depth of focus adjacent to the focal region. The depth of focus may be in the range of about 300 nm to about 2000 mn.

Another aspect of the present invention is to provide an apparatus comprising a first portion having sides shaped to direct a guided electromagnetic planar waveguide mode to a focal region and a second portion adjacent the focal region.

A further aspect of the present invention is to provide a data storage system comprising a recording medium and a recording head positioned adjacent to the recording medium. The recording head includes a write pole and a planar solid immersion mirror for heating the recording medium proximate to where the write pole applies a magnetic write field to the recording medium. The planar solid immersion mirror includes a reflective portion having edges shaped to direct a guided electromagnetic planar waveguide mode to a focal region outside of the reflective portion and a non-reflective portion adjacent the reflective portion that contains at least a part of the focal region. In one embodiment, the recording head is structured and arranged as a heat assisted magnetic recording head.

These and other aspects of the present invention will be more apparent from the following description.

### BRIEF DESCRIPTION OF THE DRAWINGS

FIG. 1 is a pictorial representation of a data storage system that can include a recording head constructed in accordance with this invention.

FIG. 2 is an isometric view of a planar solid immersion mirror constructed in accordance with the invention.

FIG. 3 is a sectional view taken along lines 3-3 of FIG. 2.

FIG. 4 is a sectional view taken along lines 4-4 of FIG. 2.

FIG. 5 is a partial sectional view taken along lines 5-5 of FIG. 2.

FIG. 6 is an enlarged view of a focal region and depth of focus generated in accordance with the invention.

FIG. 7 is an illustration of a planar solid immersion mirror and the geometry in accordance therewith for constructing an embodiment of the invention.

FIG. 8 is a graphical illustration of coordinates (x,y) for forming a planar solid immersion mirror in accordance with the invention.

### DETAILED DESCRIPTION

The invention encompasses optical devices, such as, for example, a planar solid immersion mirror, that can produce a small optical spot that can be used, for example, in magnetic, magneto-optical and/or optical recording heads with various types of recording media. The invention is particularly suitable for use with a data storage system, and more particularly for such a system that utilizes heat-assisted magnetic recording (HAMR). In addition, the invention may be used, for example, in optical probe data storage devices or in near field microscopy devices.

For HAMR, electromagnetic radiation (for example light) is used to heat a portion of a surface of a magnetic storage medium. This facilitates the subsequent recording of magnetic information in the heated portion of the medium. HAMR heads include means for directing the electromagnetic radiation onto the surface of the storage medium, and an associated means for producing a magnetic signal for affecting the magnetization of the storage medium.

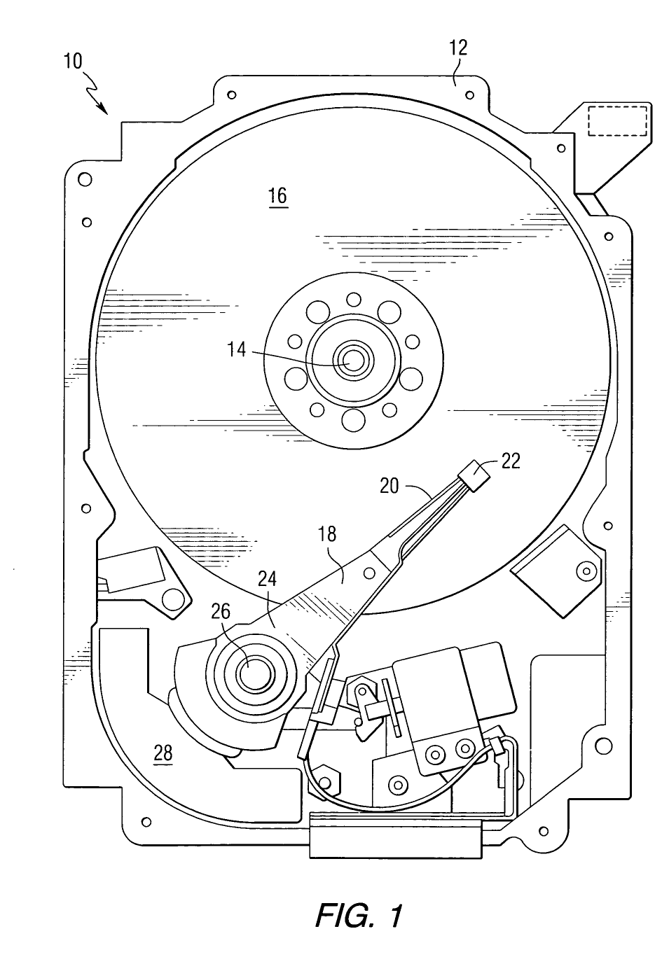

FIG. 1 is a pictorial representation of a disc drive 10 that can utilize a heat assisted magnetic recording head constructed in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing. At least one arm 18 is contained within the housing 12, with each arm 18 having a first end 20 with a recording head mounted on a slider 22, and a second end 24 pivotally mounted on a shaft by a bearing 26. An actuator motor 28 is located at the arm's second end 24 for pivoting the arm 18 to position the recording head over a desired sector or track of the disc 16. The actuator motor 28 is regulated by a controller, which is not shown in this view and is well known in the art.

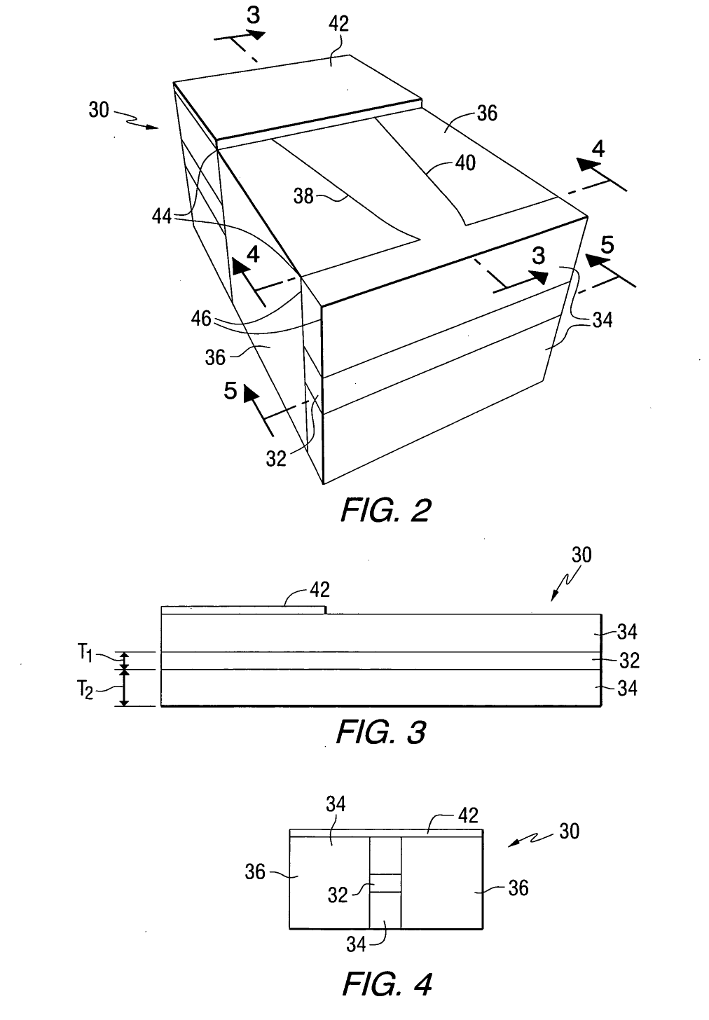

FIGS. 2-5 illustrate views of an embodiment of a planar solid immersion mirror (PSIM) 30 constructed in accordance with the invention. Planar solid immersion mirror as used herein generally refers to an optical device constructed from a planar waveguide that has shaped edges for reflecting light. The light may be reflected to, for example, a focus or focal region. The PSIM 30 can be structured and arranged, for example, as part of the recording head mounted on the slider 22 for heating the recording medium 16 proximate to where a write pole applies the magnetic write field to the recording medium 16.

The PSIM 30 may include multiple layers of material having varying refractive indexes. For example, the PSIM 30 can include a core layer 32 with at least one cladding layer 34 formed on the sides thereof (see FIGS. 2-4). The core layer 32 may have a refractive index greater than a refractive index of the cladding layer 34. This enables the core layer 32 to more efficiently transmit the light energy or electromagnetic wave for heating the recording medium 16. The core layer 32 may have a refractive index of about 1.9 to about 4.0. In contrast, the cladding layer 34 may have a refractive index of about 1.0 to about 2.0. By forming the core layer 32 with a higher refractive index than the cladding layer 34, 1the core layer 32 is able to most efficiently guide a propagating or guided electromagnetic planar waveguide mode by total internal reflection. In addition, by increasing the ratio of the core layer 32 refractive index to the cladding layer 34 refractive index (for the refractive index ranges stated herein), the energy of the propagating or guided mode can be more greatly confined within the core layer 32. As used herein, the term propagating or guided electromagnetic planar waveguide mode generally refers to optical modes which are presented as a solution of the eigenvalue equation, which is derived from Maxwell's equations subject to the boundary conditions generally imposed by the waveguide geometry.

The core layer 32 may be formed of a material such as, for example, Ta₂O₅, TiO₂, ZnSe, Si, SiN, GaP or GaN. In addition, the core layer 32 may have a thickness T₁ (see FIG. 3) of about 20 nm to about 500 nm. The cladding layer 34 may be formed of a material such as, for example, SiO₂, air, Al₂O₃ or MgF₂. The cladding layer 34 may have a thickness T₂ (see FIG. 3) in the range of about 200 nm to about 2000 nm. The cladding layer 34 should be sufficiently thick such that the electric field from the propagating waveguide mode does not extend appreciably beyond the cladding layer 34 and thereby interact with any materials or structure outside of the PSIM 30. By increasing the ratio of the core layer 32 thickness to the cladding layer 34 thickness (for the thickness ranges stated herein), the energy of the propagating mode can be more greatly confined within the core layer 32.

The PSIM 30 may also include one or more reflective material layers 36 formed along the reflective edges or sides 38 and 40 to help insure low loss reflection of the electromagnetic waves within the PSIM 30. The reflective material layers 36 may be formed of, for example, Au, Ag, Al, Cu, Pt or Ir.

The PSIM 30 may also include a grating coupler 42 for coupling the electromagnetic waves into the PSIM 30. A light source (not shown) such as a laser diode may be utilized for directing the electromagnetic waves toward the grating coupler 42, as is generally known.

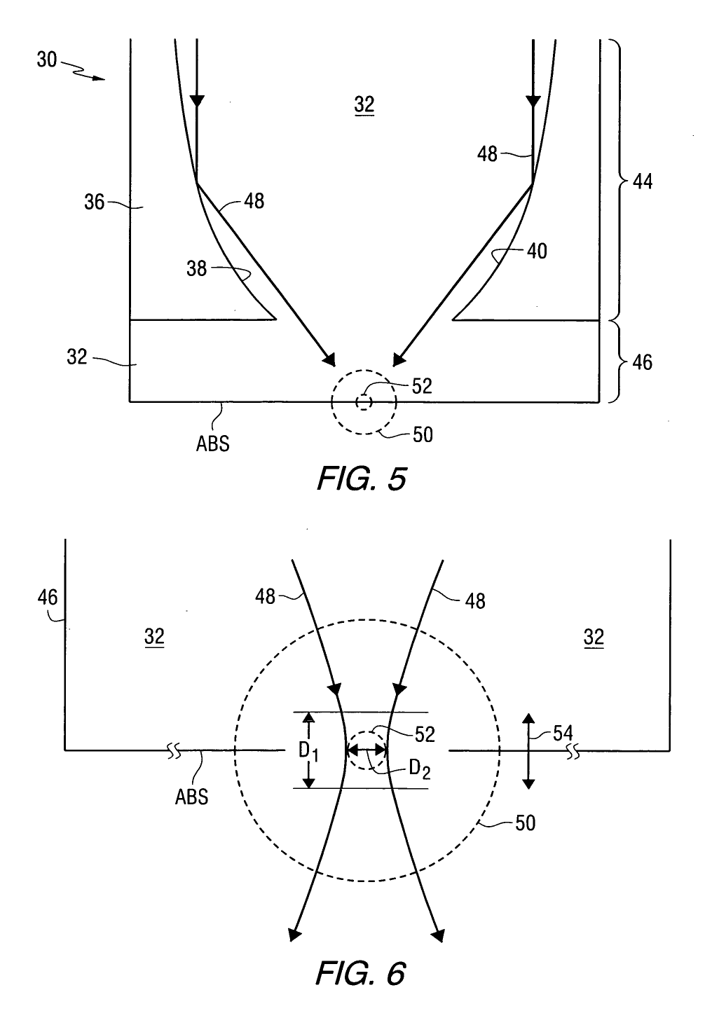

Referring to FIG. 5, there is illustrated a partial sectional view of the PSIM 30 with the sectional view taken along line 5-5 through the core layer 32 as shown in FIG. 2. The PSIM 30 includes a first portion or reflective portion 44 and a second portion or non-reflective portion 46. The reflective portion 44 includes the sides 38 and 40 for directing a propagating or guided electromagnetic planar waveguide mode, e.g., electromagnetic waves represented by arrows 48, toward a focal region 50 so as to generate an optical spot 52. The focal region 50 and the optical spot 52 are contained at least partially within the non-reflective portion 46 of the PSIM 30 and adjacent an air-bearing surface (ABS).

Referring to FIG. 6, there is illustrated an enlarged view of the focal region 50 relative to the ABS of the core layer 32 of the non-reflective portion 46. Specifically, FIG. 6 illustrates that the waves 48 pass through the focal region 50 to form the optical spot 52 adjacent the ABS. By forming the sides 38 and 40 (shown, for example, in FIG. 5) in accordance with the invention, a depth of focus D₁ in the range of about 300 nm to about 2000 nm can be generated. For example, the depth of focus may be up to about 2.4 times the wavelength of the waves 48 (which may be, for example, in the range of about 125 nm to about 850 nm). The optical spot 52 may have a dimension D_{2,}, i.e. diameter, in the range of about 250 nm to about 500 nm. It will be appreciated that the illustration set forth in FIG. 6 is merely a schematic representation of what generally occurs at the ABS and that the actual location of the optical spot 52 and the depth of focus, as represented by dimension D₁, may fluctuate above or below the ABS as indicated by arrow 54.

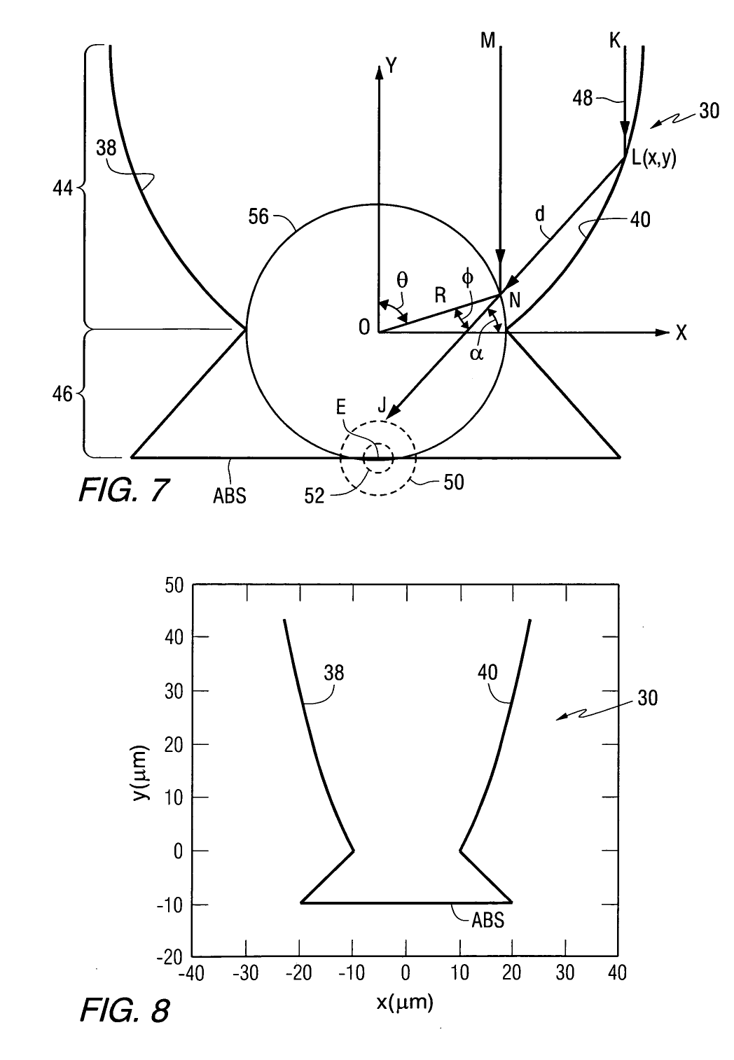

As described herein, the sides 38 and 40 of the PSIM 30 are shaped to direct a propagating electromagnetic planar waveguide mode, e.g., electromagnetic waves 48, to the focal region 50. The geometry for determining the shape of the sides 38 and 40 is set forth in FIG. 7 and the following description will explain the mathematical derivations for determining a point (x,y) on the sides 38 and 40 in accordance with the invention.

Still referring to FIG. 7, when a plane wave is focused by a circular particle such as a lens 56 in a two dimensional geometry, an optical nanojet is obtained for an appropriate choice of the refractive index of the circular particle or lens 56. In accordance with the present invention, a reflective geometry such as, for example, the PSIM 30, is provided for generating optical nanojets. The plane wave propagates in the −Y direction. In the lens 56 geometry, an incident ray MN is refracted into ray NJ. When the refractive index of the lens (denoted by η) is approximately 2.0, a nanojet is obtained in the vicinity of point E. For the PSIM 30 geometry, the region between the sides 38 and 40 has a mode index equal to about the refractive index of the lens 56. The ray NJ is obtained by reflection of incident ray KL at point L. The actual reflective geometry for the PSIM 30 lies above the X axis. The region below the X axis, i.e., the non-reflective portion 46, can be arbitrary as long as it does not block the electromagnetic waves or rays reflected by the sides 38 and 40 above the X axis. Assuming that the radius R of the lens 56 is much larger than the wavelength of light in free space, the nanojet is not sensitive to the curvature of the exit surface, i.e., the ABS. Therefore, it can be a planar surface, such as the ABS, for the example of the reflective geometry. The exit planar surface, i.e., the ABS, is not reflecting. The ABS terminates the region with higher refractive index such that the region below it is, for example, free space. Thus, it will be appreciated that an aspect of the invention is to design the PSIM 30 such that the phase distribution of the refracted field in the case of the lens 56 geometry is generally the same as that of the PSIM 30 reflected field.

Still referring to FIG. 7, the relevant mathematical derivations for determining a point (x,y) on the sides 38 and 40 of the PSIM 30 is set forth below, wherein the following variables are applicable:
η: Angle of incidence for the analogous lens 56.
φ: Angle of refraction for the analogous lens 56.
α: Angle the reflected ray (for the PSIM) 30 or the refracted ray (for the analogous lens 56) makes with the X axis.
R: Radius of the analogous lens 56 or the opening of the first portion of the PSIM 30 along the X-axis.
d: The difference in the path lengths of the ray reflected off the PSIM 30 sidewall and the corresponding ray refracted off the lens 56.
n: index of refraction.

$$\begin{matrix}α + ( θ - ϕ ) = 90 ° & Equation 1 \\ n = \frac{sin θ}{sin ϕ} & Equation 2\end{matrix}$$

Equation 1 is obtained from the geometry set forth in FIG. 7 and Equation 2 is obtained from Snell's Law.

A nanojet will be obtained in the PSIM 30 geometry if the difference in the phase at a point on the hypothetical surface coincident with the lens 56 surface and the phase on the corresponding point in the lens geometry has the same value for all points. This can be insured by equating the difference between the optical path lengths from infinity to the hypothetical surface for an arbitrary α and α=0 for the lens 56 and the PSIM 30 geometries. If the physical distance between L and N is d, the following equation results:
−R cos θ=−n(R cos θ+d sin α)+nd Equation 3

If the point L has coordinates (x,y), then the following equations can be obtained:
x=R sin θ+d cos α
y=R cos θ+d sin α Equations 4 & 5
The following equations can be obtained for the coordinates (x,y):

$$x = R sin θ + \frac{( n - 1 ) R cos θ sin ( θ - ϕ )}{n [ 1 - cos ( θ - ϕ ) ]} \\ y = R cos θ + \frac{( n - 1 ) R cos θ cos ( θ - ϕ )}{n [ 1 - cos ( θ - ϕ ) ]} \qquad Equations 6 \& 7$$

Using Equation 1 to eliminate φ from Equation 6 and Equation 7 results in the following for determining the point (x,y) on the sides 38 and 40 such as, for example, point L illustrated in FIG. 7:

$$x = R [ sin θ + \frac{( n - 1 ) sin 2 θ ( \sqrt{{n}^{2} - {sin}^{2} θ} - cos θ )}{2 n ( n - {sin}^{2} θ - cos θ \sqrt{{n}^{2} - {sin}^{2} θ} )} ] \\ y = \frac{R cos θ}{n} [ \frac{{n}^{2} - {sin}^{2} θ - cos θ \sqrt{{n}^{2} - {sin}^{2} θ}}{n ( n - {sin}^{2} θ - cos θ \sqrt{{n}^{2} - {sin}^{2} θ} )} ] \qquad Equation 8 \& 9$$

It will be appreciated that coordinates x and y can be obtained as a function of the parameter θ. In the lens 56 geometry, the range of θ is about 0° to about 90°. In the reflective PSIM 30 geometry, θ is in the range of about 15° to about 90°. Thus, an important aspect of the invention is to obtain φ using Snell's Law for a given θ, and then the parametric curve for the reflecting surface using the above equations for determining coordinates x and y

FIG. 8 illustrates the PSIM 30 geometry for R=10 μm and the resulting coordinates x and y based upon the equations set forth hereinabove.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. An apparatus, comprising:
a first portion having sides shaped to direct a guided electromagnetic planar waveguide mode to a focal region outside of the first portion; and
a second portion adjacent the first portion, the second portion containing at least a part of the focal region.

2. The apparatus of claim 1, wherein the first portion and the second portion are structured and arranged to provide a depth of focus in the range of about 300 nm to about 2000 nm adjacent the focal region.

3. The apparatus of claim 1, wherein the first portion and the second portion are structured and arranged to provide an optical spot substantially within the focal region.

4. The apparatus of claim 1, wherein a point (x,y) on the sides of the first portion is defined by:
$$x = R [ sin θ + \frac{( n - 1 ) sin 2 θ ( \sqrt{{n}^{2} - {sin}^{2} θ} - cos θ )}{2 n ( n - {sin}^{2} θ - cos θ \sqrt{{n}^{2} - {sin}^{2} θ} )} ]$$
$$y = \frac{R cos θ}{n} [ \frac{{n}^{2} - {sin}^{2} θ - cos θ \sqrt{{n}^{2} - {sin}^{2} θ}}{n ( n - {sin}^{2} θ - cos θ \sqrt{{n}^{2} - {sin}^{2} θ} )} ]$$

5. The apparatus of claim 4, wherein θ is in the range of about 15° to about 90°.

6. The apparatus of claim 4, wherein n is in the range of about 1.8 to about 2.1.

7. The apparatus of claim 1, further comprising a grating coupler for coupling the guided electromagnetic planar waveguide mode into the first portion.

8. The apparatus of claim 1, wherein the first portion and the second portion each include a core layer and a cladding layer adjacent the core layer.

9. The apparatus of claim 8, wherein the core layer includes at least one of Ta₂O₅, TiO₂, ZnSe, Si, SiN, GaP or GaN.

10. The apparatus of claim 8, wherein the core layer in the first portion has substantially the same refractive index as the core layer in the second portion.

11. The apparatus of claim 8, wherein the cladding layer in the first portion has the same refractive index as the cladding layer in the second portion.

12. A planar solid immersion mirror, comprising:
a reflective portion with sides; and
a non-reflective portion adjacent said reflective portion, said non-reflective portion containing at least a part of a focal region and wherein said focal region is outside of said reflective portion.

13. The planar solid immersion mirror of claim 12, wherein the reflective portion and the non-reflective portion are structured and arranged to provide a depth of focus in the range of about 300 nm to about 2000 nm adjacent the focal region.

14. The planar solid immersion mirror of claim 12, wherein the reflective portion and the non-reflective portion are structured and arranged to provide an optical spot substantially within the focal region.

15. The planar solid immersion mirror of claim 12, wherein the sides of the reflective portion are shaped to direct a guided electromagnetic planar waveguide mode to the focal region.

16. The planar solid immersion mirror of claim 12, wherein a point (x,y) on the sides of the reflective portion is defined by:
$$x = R [ sin θ + \frac{( n - 1 ) sin 2 θ ( \sqrt{{n}^{2} - {sin}^{2} θ} - cos θ )}{2 n ( n - {sin}^{2} θ - cos θ \sqrt{{n}^{2} - {sin}^{2} θ} )} ]$$
$$y = \frac{R cos θ}{n} [ \frac{{n}^{2} - {sin}^{2} θ - cos θ \sqrt{{n}^{2} - {sin}^{2} θ}}{n ( n - {sin}^{2} θ - cos θ \sqrt{{n}^{2} - {sin}^{2} θ} )} ]$$

17. The planar solid immersion mirror of claim 12 structured and arranged for use in a data storage system.

18. A data storage system, comprising:
a recording medium; and
a recording head positioned adjacent to said recording medium, said recording head comprising:
a write pole; and
a planar solid immersion mirror comprising:
a first portion having edges shaped to direct a guided electromagnetic planar waveguide mode to a focal region outside of the first portion; and
a second portion adjacent the first portion, the second portion containing at least a part of the focal region.

19. The data storage system of claim 18, wherein the recording head is structured and arranged as a heat assisted magnetic recording head.

20. The data storage system of claim 18, wherein a point (x,y) on the edges of the first portion is defined by:
$$x = R [ sin θ + \frac{( n - 1 ) sin 2 θ ( \sqrt{{n}^{2} - {sin}^{2} θ} - cos θ )}{2 n ( n - {sin}^{2} θ - cos θ \sqrt{{n}^{2} - {sin}^{2} θ} )} ]$$
$$y = \frac{R cos θ}{n} [ \frac{{n}^{2} - {sin}^{2} θ - cos θ \sqrt{{n}^{2} - {sin}^{2} θ}}{n ( n - {sin}^{2} θ - cos θ \sqrt{{n}^{2} - {sin}^{2} θ} )} ]$$
